(19) United States
(12) Patent Application Publication
(10) Pub. No.: US 2024/0009908 A1
(43) Pub. Date: Jan. 11, 2024

(54) METHOD OF MAKING AND USE OF STERILE PLASTIC BAG

(71) Applicant: Whirl-Pak, Madison, WI (US)

(72) Inventors: Nick Bruns, Madison, WI (US); Greg Hood, Dublin, OH (US)

(21) Appl. No.: 18/348,020

(22) Filed: Jul. 6, 2023

Related U.S. Application Data
(60) Provisional application No. 63/367,772, filed on Jul. 6, 2022.

(51) Int. Cl. B29C 48/10; B29C 48/00; B65B 51/26; B29C 48/27

(52) U.S. Cl. CPC B29C 48/10; B29C 48/0022; B29C 48/0023; B65B 51/26; B29C 48/274; B29L 2031/7128

(57) ABSTRACT

Provided is a method of making a sterilized flat plastic bag including the steps of: forming a roll of a tubular polymeric film in a blown film extrusion process, providing the roll of tubular polymeric film to a bag making process, and forming a sterilized flat plastic bag, wherein the tubular film is not slit in the longitudinal direction during any step of the method, and therefore avoids the necessity of a separate sterilizing step. Also provided is a sterilized flat plastic bag made according to the foregoing method of making and a method of using such a sterilized flat plastic bag to collect and retain a product sample and eliminate product contamination. The sterilized plastic bag made according to the above method provides improved tear strength and resistance to rupture when containing product.

### CROSS-REFERENCE TO RELATED APPLICATIONS

This is a non-provisional application that claims priority to U.S. Provisional Application No. 63/367,772 filed on Jul. 6, 2022, herein incorporated by reference in its entirety.

### FIELD

The present disclosure relates to the field of plastic bags. It more particularly relates to methods of making and using sterile plastic bags. It still more particularly relates to methods of making and using sterile plastic sample collection bags that are sealed on all sides that are produced from a blown film process and a subsequent bag making process that does not require separate slitting and sterilization process steps.

### BACKGROUND

Plastics bags have a wide variety of uses for packaging and storing various materials, including, but not limited to, food and beverage items, pharmaceuticals, health and beauty items and lawn and garden items. These plastic bags are used to store a wide array of components including, but not limited to, liquids, dry solids, powdered solids and combination of liquid and solids. These plastics bags are often referred to as sample collection bags and are often times sterilized in a separate process step after bag forming via ethylene oxide gas treatment or gamma irradiation treatment.

One issue with prior art processes for making these sample collection bags is that the bags are made in 4 separate and distinct process steps. Referring to FIG. 1 (Prior Art Method), the first step 10 in the prior art process is producing a blown film/tubular film that is wound into a roll. The second step 20 in the prior art process is taking the roll of blown or tubular film and unwinding, slitting and rewinding it to form rolls of non-tubular flat film. The third step 30 in the prior art process is taking the rolls of non-tubular flat film and unwinding them and running them through a bag making machine to form bags which are stacked and packaged. The fourth step 40 in the prior art process is taking palletized stacks of the bags and subjecting them to sterilization via ethylene oxide gas treatment or gamma irradiation treatment. These four separate and distinct process steps result in many inefficiencies and associated costs in producing the sterilized sample collection bags.

Based on the above identified deficiencies with existing methods for making plastic sterile sample collection bags, there is a need for a simpler, more streamlined, less costly and more efficient process for producing such sterilized plastic sample collection bags.

### SUMMARY

One aspect of the present disclosure provides a method of making a sterilized flat plastic bag comprising the steps of: i) forming a roll of a tubular polymeric film in a blown film extrusion process, wherein the roll ranges in width from 6 inches to 60 inches; ii) providing the roll of tubular polymeric film to a bag making process comprising the steps of:
a) unwinding the roll of tubular polymeric film,
b) continuously heat sealing the unwound tubular polymeric film proximate the machine direction (longitudinal direction) edges and periodically heat sealing along the transverse direction to form bag side heat seals and end heat seals respectively, and
c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top end heat seal area and a bottom end heat seal area,
with the proviso that the tubular film is not slit in the longitudinal direction during any step of the method, and
with the proviso that the sterilized flat bag is not subjected to a separate sterilizing step during any step of the method.

Another aspect of the present disclosure provides a sterilized flat plastic bag with improved strength against tear and rupture when filled with product, wherein the sterilized plastic bag is made by the method of the preceding paragraph.

Still another aspect of the present disclosure provides for a method of using a sterilized plastic bag to collect and retain a product sample and eliminate product contamination comprising:
i) forming a sterilized flat plastic bag from the following steps:
   forming a roll of a tubular polymeric film in a blown film extrusion process, wherein the roll ranges in width from 6 inches to 60 inches;
   providing the roll of tubular polymeric film to a bag making process comprising the steps of:
   a) unwinding the roll of tubular polymeric film,
   b) continuously heat sealing the unwound tubular polymeric film proximate the machine direction (longitudinal direction) edges and periodically heat sealing along the transverse direction to form bag side heat seals and end heat seals respectively, and c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top heat seal area and a bottom heat seal area,
   d) forming a bag opening mechanism located proximate a top edge of the sterilized flat plastic bag and below the top heat seal area, wherein the bag opening mechanism includes one or more perforations, scores or cuts in the side heat seal areas and optionally the front wall and the back wall of the sterilized flat plastic bag to form a removable tear strip,
   e) forming a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag, and, wherein the first closure strip and the second closure strip include a malleable wire embedded in the closure strip that traverses substantially the entire length of the closure strip or that traverses a majority of the length of the closure strip,
   f) forming one or more pull tabs affixed to the front wall, the back wall or a combination, wherein the one or more pull tabs are located between the first closure strip and the front wall, between the second closure strip and the back wall, or a combination thereof, and
   with the proviso that the tubular film is not slit in the longitudinal direction during any step of the method, and with the proviso that the sterilized flat bag is not subjected to a separate sterilizing step during any step of the method,
ii) removing the removable tear strip from the sterilized plastic bag;
iii) opening the sterilized plastic bag with the one or more pull tabs;
iv) filling the internal collection space of the open sterilized plastic bag with a product sample; and
v) closing the filled open sterilized plastic bag with the bag closing mechanism.

### BRIEF DESCRIPTION OF THE DRAWINGS

To assist those of ordinary skill in the relevant art in making and using the subject matter hereof, reference is made to the appended drawings, wherein:

FIG. 1 is a process flow diagram of the prior art process for make sterilized plastic bags for sample collection.

FIG. 2 is a process flow diagram of the inventive process for making sterilized plastic bags for sample collection including blown process processing and bag making.

FIG. 3 is a process flow diagram of the bag making process of the inventive process for making sterilized plastic bags for sample collection.

FIG. 4 is a front elevation view of an exemplary sterilized plastic bag for sample collection produced by the methods depicted in FIGS. 2 and 3.

### DETAILED DESCRIPTION

All numerical values within the detailed description and the claims herein are modified by “about” or “approximately” the indicated value, and take into account experimental error and variations that would be expected by a person having ordinary skill in the art. In the present application, the phrase “sealant areas” is synonymous with “sealed areas” or “seals” which is defined as an area or areas where two or more plastic films are bonded together either with heat or thermally (heat seal), with ultrasonic energy (ultrasonic seal), or with adhesive (adhesive seal).

Although the present invention will be described with reference to the embodiments shown in the drawings, it should be understood that the present exemplary embodiments can be used individually or in any suitable combination thereof. Although the aspects of the disclosed embodiments will be described with reference to the drawings, it should be understood that the aspects of the disclosed embodiment can be embodied in many alternate forms. In addition, any suitable size, shape or type of elements or materials could be used for the sterilized plastic bags disclosed herein.

### Method of Making Sterilized Plastic Bag Overview

The improved method of making sterilized plastic sample collection bags of the instant disclosure provides the following benefits relative to prior art methods of making sterilized sample collection bags: less costly to produce due to few process steps in the overall process, no need for a separate bag sterilization step, no need for unwinding the tubular blown film and slitting it into appropriate widths for subsequent bag making, and formation of a stronger bag against rupture by sealing it on all four sides or edges.

The improved method of making sterilized sample collection bags of the instant disclosure includes the following steps: a) forming a roll of tubular film in a single layer or multi-layer blown film extrusion process, b) unwinding the roll of tubular film and feeding the unwound tubular film into a flat bag making process; c) forming a square or rectangular shaped flat bag in the bag making process, d) heat sealing the square or rectangular shaped flat bag on four sides or edges in the flat bag making process to form a rectangular or square shaped heat sealed tubular film; and d) cutting the heat sealed tubular film in the cross or transverse direction in the flat bag making process to form a sterilized flat bag heat sealed on four sides or edges with the proviso that the tubular film is not slit in the longitudinal direction during any step of the method and with the proviso that the sterilized flat bag is not subjected to a separate sterilizing step.

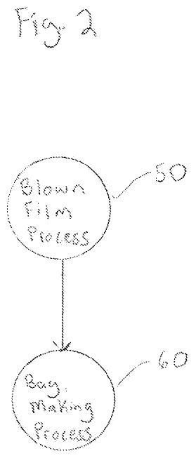

Referring to FIG. 2, the improved method of making sterilized sample collection bags of the instant disclosure includes two primary process steps with the first step being the formation of a tubular film in a blown film extrusion process 50 and second step being a bag making process for taking the tubular film and converting it into sterilized plastic bags for sample collection. The tubular film formed in the blown film extrusion process 50 may include from one to six polymeric layers, or two to five polymeric layers, or three to four polymeric layers. The polymeric layers may be formed from polymers selected from the group consisting of low density polyethylene, linear low density polyethylene, high density polyethylene, polyester, polypropylene, ethylene-propylene copolymer, ethylene-propylene-butene-1 terpolymer, propylene-butene-1 copolymer, ethylene vinyl acetate, polyamide, polylactic acid, polyester from sugar cane or corn derived ethanol, and starch-based polymers. The surface layer of the tubular film on the inside of the tube is a heat sealable polymeric layer selected from the group consisting of low density polyethylene, linear low density polyethylene, ethylene-propylene copolymer, ethylene-propylene-butene-1 terpolymer, ethylene vinyl acetate, propylene-butene-1 copolymer.

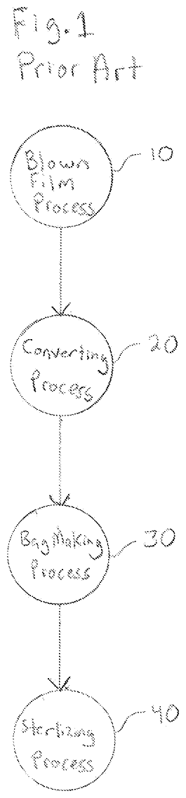

The inventive process of FIG. 2 eliminates two steps in the prior art process of FIG. 1 with those two steps being the converting process step 20 and the bag sterilizing process step 40. In the inventive process of FIG. 2, the tubular film is not converted into a flat film via an unwinding, slitting and rewinding process, which eliminates the need for a separate bag sterilizing process step 40. Therefore, by maintaining the tubular film as a tube throughout the bag making process, the inside surfaces of the tube are not exposed to the ambient environment and the associated contamination, which eliminates the need for a sterilizing step at the end of the process. The inside surfaces of the tubular film are in a sterile state through the blown film extrusion process, and such state is maintained through the bag making process of the inventive process because the tubular film is not converted into a flat film through a converting process. The inventive process disclosed herein also heat seals the tubular film on all 4 side or edges of the bag to provide a bag with increased strength and mechanical integrity, which may be beneficial when packaging liquids or solids of a high density.

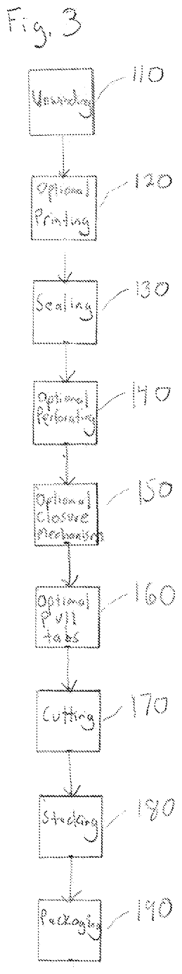

FIG. 3 is a process flow diagram detailing the process steps for the bag making process 60 of FIG. 2. The bag making process commences by unwinding a roll of tubular film 110 formed from the blown film extrusion process step 50 from an unwind stand. The roll of tubular is sized in terms of the width being the same as the desired width of the sterilized plastic bag for sample collection. The range of bag widths may range for 6 inches to 60 inches, or 8 inches to 50 inches, or 10 inches to 40 inches, or 12 inches to 30 inches, or 14 inches to 25 inches, or 16 inches to 20 inches.

After the unwinding step, the tubular film may optionally go to a surface printing step 120 for applying graphics to the outside surface of the tubular film utilizing a flexographic or rotogravure printing processes with a solvent based ink system or a water based ink system. Non-limiting exemplary ink systems include acrylic, cellulosic, epoxy, urethane or polyvinylidene dichloride (PVDC) systems.

After the optional surface printing step 120, the tubular film is transported to a sealing process 130 as part of the bag making process. While the tubular film lays flat, heat seals are formed by heated platens in both the longitudinal and traverse directions under appropriate heat and pressure. The longitudinal heat seals are made adjacent to the longitudinal edges of the tubular film to form the side seals of the bag. The traverse heat seals are made across the width of the tubular film and at a frequency desired for a particular bag height to form top and bottom seals of the bag. The height or length of the sterilized plastic bag for sample collection may range from 6 to 60 inches, or 8 inches to 50 inches, or 10 inches to 40 inches, or 12 inches to 30 inches, or 14 inches to 25 inches, or 16 inches to 20 inches.

After the sealing step 130, the sealed tubular film may optionally go to a step to provide a bag opening mechanism 140 proximate a top edge of the bag. The optional step of providing a bag opening mechanism 140 may occur by providing a line of perforations that transverses across the width of the tubular film just below a top edge of the bag. The improved method of making sterilized sample collection bags of the instant disclosure may include this optional step in the flat bag making process of providing a bag opening mechanism located proximate a top edge of the sterilized flat bag and below a top heat seal area. The bag opening mechanism includes one or more perforations, scores, notches or cuts in one or two side heat seal areas and optionally a front and a back wall of the sterilized flat bag to form a removable tear strip.

After the optional perforating step to provide a bag opening mechanism 140 described above, the sealed tubular film may optionally go to a step to provide a bag closure or closing mechanism 150 located proximate and below the removable tear strip (bag opening mechanism). The bag closing mechanism includes a first closure strip sealed to the front wall of the bag and a second closure strip sealed to the back wall of the bag, wherein the first and second closure strips are opposed to each other and extend beyond the side edges of the bag. The first closure strip and the second closure strip may include a malleable wire embedded in the closure strip that traverses substantially the entire length of the closure strip or that traverses a majority of the length of the closure strip. The malleable wire may be selected from the group consisting of aluminum, bronze, copper, nickel, cobalt, brass, copper-zinc alloys, and zinc. The closure strips may be colored in order to make them more visible to the user with yellow being a particularly preferred color. The closure strips may also be optionally printed with supplier and brand information.

After the optional bag closure or closing mechanism step 150, the sealed tubular film may optionally go to a step to provide one or more pull tabs 160 on the outside surface of the bag to assist with the opening and closing of the mouth of the bag. The one or more pull tabs may be affixed to the front wall, the back wall or a combination thereof of the sterilized sample collection bag. The one or more pull tabs may also be located between the first closure strip and the front wall, between the second closure strip and the back wall, or a combination thereof. The one or more pull tabs are generally located proximate and below the removable tear strip (bag opening mechanism).

After the step of providing the one or more pull tabs 160, the sealed tubular film is then cut in the traverse direction 170 about midway between the transverse heat seals in the sealed tubular film to form individual sterilized plastic sample collection bags. By cutting the sealed tubular film in the traverse direction 170 about midway between the transverse heat seals, there is formed a bottom end heat seal of one bag and a top end heat seal of an adjacent bag.

In the next step of the bag making process 60, the individual sterilized plastic sample collection bags are stacked on top of each other 180 to allow for ease of packaging. Finally, the stacks of sterilized plastic sample collection bags are packaged (such as for example, shrink wrapped, banded and/or boxed) 190 for subsequent transport and shipping.

### Sterilized Bag Produced by the Above Inventive Method

The methods of producing plastic sterilized bags described above are particularly useful as product sampling bags or product collection bags, which are used to collect and retain samples of product periodically during manufacturing operations. The plastic sterilized bags of the instant disclosure may be made of any shape and size.

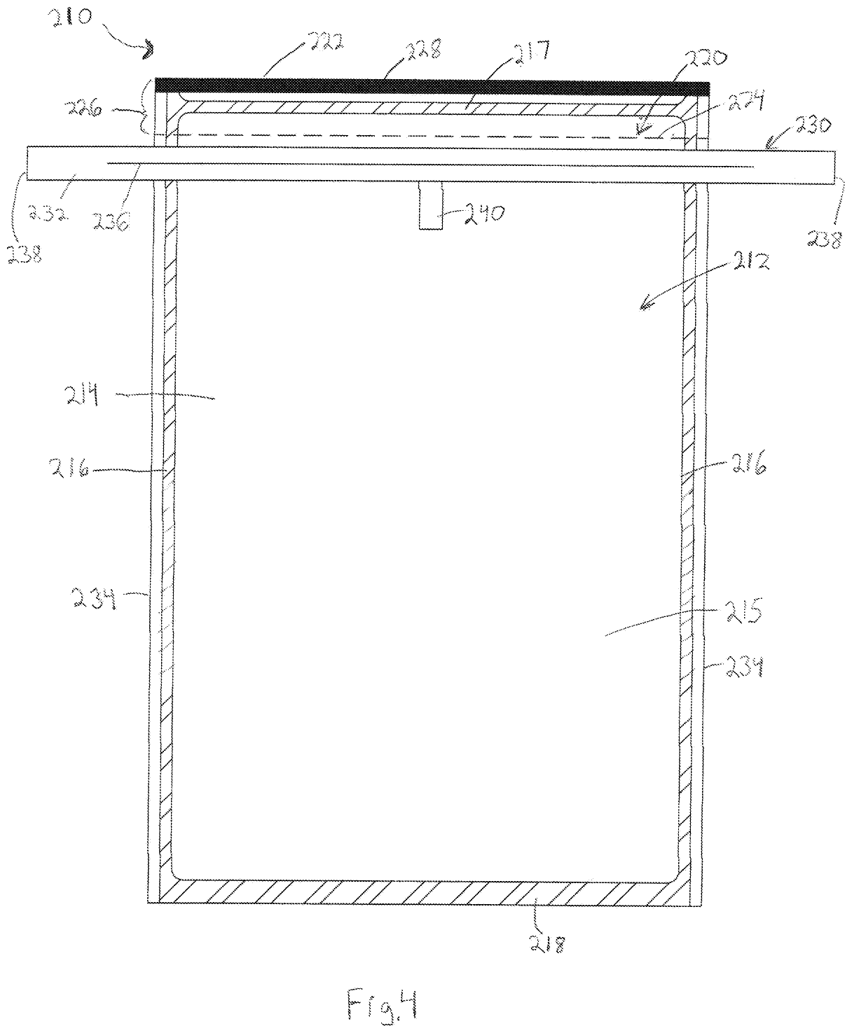

FIG. 4 is a front elevation view of an exemplary rectangular shaped sterilized plastic bag for sample collection produced by the methods described above and depicted in FIGS. 2 and 3. The flexible body 212 of the bag 210 may be of a shape, including, but not limited to, rectangular, square, circular, oval, triangle, trapezoid, pentagon, hexagon, heptagon and octagon with rectangular or square shapes being advantageous. In an advantageous form, the sterilized plastic bags of the instant disclosure are of a rectangular shape with the length of the bag being greater than the width of the bag.

In one embodiment of the sterilized plastic bag made by the methods disclosed herein, the bag includes a flexible body formed from a single or multi-layer polymeric film including an opposed front wall and back wall sealed together around the periphery of the front wall and the back wall (all 4 sides of the bag) to form an internal collection space including two side heat seal areas, a top heat seal area and a bottom heat seal area, and an optional bag opening mechanism located proximate a top edge of the flexible body and below the top heat seal area. The bag including the optional opening mechanism comprises one or more perforations, scores or cuts in the one or two side seal areas and optionally the front and back wall to form a removable tear strip.

In another embodiment of the sterilized plastic bag made by the methods disclosed herein, the bag includes a flexible body formed from a single or multi-layer polymeric film including an opposed front wall and back wall sealed together around the periphery of the front wall and the back wall (all 4 sides of the bag) to form an internal collection space including two side heat seal areas, a top heat seal area and a bottom heat seal area. The bag also includes a bag opening mechanism located proximate a top edge of the flexible body and below the top seal area, which comprises one or more perforations, scores or cuts in the one or two side seal areas and optionally the front and back wall to form a removable tear strip. The bag also includes an optional bag closing mechanism located proximate and below the removable tear strip, which includes a first closure strip sealed to the front wall of the bag and a second closure strip sealed to the back wall of the bag, wherein the first and second closure strips are opposed to each other and extend beyond the side edges of the bag and which include a malleable wire embedded in the strips that traverses substantially the entire length of the closure strip or that traverses a majority of the length of the closure strip. The bag also optionally includes one or more pull tabs affixed to the front wall, the back wall or a combination and are located between the first closure strip and the front wall, between the second closure strip and the back wall, or a combination thereof.

Referring to FIG. 4, an exemplary sterilized plastic bag made by the methods disclosed herein of the instant disclosure is depicted. The sterilized plastic bag 210 includes a flexible body 212 formed from a single or multi-layer polymeric blown or tubular film. The flexible body 212 includes an opposed front wall 214 and back wall (not shown) heat sealed together around the periphery (all 4 sides of the bag) of the front wall 214 and the back wall (not shown) to form an internal collection space 215 including two side heat seal areas 216, a top heat seal area 217 and a bottom heat seal area 218.

Also included as part of the sterilized plastic bag 210 is bag opening mechanism 220 located proximate a top edge 222 of the flexible body 212 and below the top heat seal area 217. The bag opening mechanism 220 includes a line of perforations, scores or cuts 224 in the two side heat seal areas 216 and the front wall 214 and the back wall (not shown) to form a removable tear strip 226. The line of perforations, scores or cuts 224 facilitate the tearing of the tear strip 226 from the top portion of the flexible body 212 of the sterilized bag 210. The line of perforations, lines or cuts 224 may be of various shapes and configurations, including, but not limited to, dotted lines, dashed lines or any other form that produces a segment or series of perforations in the two side seal areas 216, also optionally the front wall 214 and also optionally the back wall (not shown). The line of perforations, lines or cuts 224 may pass through the entire thickness of the two side heat seal areas 216, the front wall 214 and the back wall (not shown) or alternatively may just pass through a portion of the thickness, such as 30% of the thickness or less, or 50% of the thickness or less, or 80% of the thickness or less in order to improve the integrity of the bag opening mechanism 220 against contamination and improve its mechanical strength and integrity. The line of perforations, lines or cuts 224 are generally positioned from 0.1 to 1.8 inches, or 0.2 to 1.4 inches, or 0.3 to 1.2 inches, or 0.4 to 1 inch, or 0.5 to 0.8 inches from the top edge 222 of the flexible body 212 of the sterilized bag 210. A notch (not shown) may also be optionally provided at one or both outside edges of the bag opening mechanism 220.

The removable tear strip 226 may also optionally include a portion that is surface printed with an ink 228 to make it more visible after it is removed from the sterilized bag. The ink 228 may be of any color, however one particularly advantageous color to aid with visual detection of the removable tear strip 226 is the color blue. The removable tear strip 226 may be completely printed with an ink 228. Alternatively, 80% of the surface area or less, or 60% of the surface area or less, or 40% of the surface area or less, or 20% of the surface area or less of the removable tear strip 226 is surface printed with an ink 228.

The exemplary sterilized plastic bag 210 may also optionally include a bag closing mechanism 230 located proximate and below the removable tear strip 226. The bag closing mechanism 230 includes a first closure strip 232 sealed to the front wall 214 of the bag 210 and a second closure strip (not shown) sealed to the back wall (not shown) of the bag 210. The first closure strip 232 and second closure strip (not shown) are opposed to each other and extend beyond the side edges 234 of the bag 210. The overall length of the closure strips 232 exceed the width of the sterilized bag 210 with such excess ranging from 0.25 to 10 inches, or 0.5 to 8 inches, or 0.6 to 7 inches, or 0.7 to 6 inches, or 0.8 to 5 inches, or 1 to 4 inches, or 2 to 3 inches. The first closure strip 232 and second closure strip (not shown) may be sealed to the front wall 214 and the back wall (not shown) of the bag 210 respectively by an adhesive sealing process, an ultrasonic sealing process or a heat sealing process.

The overall length of the closure strips 232 may range from 6 inches to 70 inches, or 8 inches to 60 inches, or 10 inches to 50 inches, or 12 inches to 40 inches, or 14 inches to 35 inches, or 16 inches to 30 inches, or 20 to 25 inches. The overall width of the closure strips 232 may range from 0.1 to 2 inches, or 0.2 to 1 inch, or 0.3 to 0.9 inches, or 0.4 to 0.75 inches, or 0.5 to 0.6. The closure strips 232 are generally positioned from 0.2 to 2 inches, or 0.3 to 1.5 inches, or 0.4 to 1.2 inches, or 0.5 to 1 inch, or 0.6 to 0.8 inches from the top edge 222 of the flexible body 212 of the sterilized bag 210.

The first closure strip 232 and the second closure strip (not shown) may optionally include a malleable wire 236 embedded in each closure strip 232 that traverses substantially the entire length of the closure strip 232 or that traverses a majority of the length of the closure strip 232. In an advantageous form shown in FIG. 4, the malleable wire 236 embedded in each closure strip 232 extends beyond the side edges 234 of the sterilized bag 210, but the malleable wire 236 may be recessed relative to each end 238 of the closure strips 232. The length of the recess of the malleable wire 236 relative to the end 238 of the closure strip 232 may range from 0.05 to 1.5 inches, or 0.1 to 1.4 inches, or 0.15 to 1.2 inches, or 0.2 to 1.1 inches, or 0.3 to 1.0 inches, or 0.4 to 0.9 inches, or 0.5 to 0.8 inches. In one advantageous form, the malleable wire 236 is recessed by about 0.75 inches relative to the end 238 of the closure strip 234. In another form, the malleable wire 236 is not recessed relative to the length of the closure strip 232 and hence is substantially the same length as the closure strip 232. The malleable wire 236 may be of a round, square, rectangular or triangular shape with a round shape being advantageous.

The exemplary sterilized plastic bag 210 may also optionally include one or more pull tabs 240 affixed to the front wall 214, the back wall (not shown) or both the front wall 214 and the back wall of the bag 210. In one advantageous form, the one or more pull tabs 240 are located between the first closure strip 232 and the front wall 214, between the second closure strip (not shown) and the back wall (not shown), or a combination thereof. In one advantageous form, the sterilized bag 210 includes two pull tabs 240 with one pull tab affixed to the front wall 214 of the bag 210 and a second pull tab (not shown) is affixed to the rear wall (not shown) of the bag 210, wherein the two pull tabs 240 are opposite each other and are centered between the side edges 234 of the bag 210. In this orientation, the pull tabs 240 may more easily facilitate the opening of the mouth of the bag 210 for insertion of a product sample (not shown) into the internal collection space 215 by pulling the pull tabs 240 outward relative to the front wall 214 and rear wall (not shown) of the bag 210. After the product sample (not shown) is inserted into the internal collection space 215, the pull tabs 240 may then be used to facilitate the closing of the mouth of the bag 210 by pushing the pull tabs 240 inward relative to the front wall 214 and rear wall (not shown) of the bag 210. The bag 210 including a product sample (not shown) may then be securely closed by utilizing the bag closing mechanism 230 by rolling from the top of the bag 210 from just below the bag opening mechanism 220 downward and then utilizing the closure strips 232 to secure the rolled down top of the bag 210 in the closed position.

The pull tabs 240 may be of any shape, including, but not limited to, square, rectangular, round, triangular and oval with a rectangular shape being advantageous. For a rectangular shaped pull tab, the overall length of the pull tab 240 may range from 0.5 to 3 inches, or 0.6 to 2.5 inches, or 0.7 to 2 inches, or 0.8 to 1.5 inches. For a rectangular shaped pull tab, the overall width of the pull tab 240 may range from 0.1 to 2 inches, or 0.2 to 1.5 inch, or 0.3 to 1 inch, or 0.4 to 0.75 inches.

The exemplary plastic sterilized bag 210 may also optionally include an insignia for a “recommended fold line” (not shown) printed on the outside surface of a front wall 214 and/or rear wall (not shown) to provide an indication of the maximum fill depth for product within the bag 210 while still allowing for securing closing of the top portion of the bag 210. The optional “recommended fold line” marking may range from 1.5 to 6 inches, or 2 to 5 inches, or 2.3 to 4.5 inches, or 2.5 to 4.0 inches from the top edge 222 of the flexible body 212 of the bag 210.

The exemplary sterilized plastic bag 210 includes a flexible body 212 that may be formed from a single layer or multi-layer polymeric tubular film in a single layer or multi-layer blown film extrusion/coextrusion process. The multi-layer polymeric film may include from one to six coextruded layers. Non-limiting exemplary polymers that may be used for the single layer or multi-layer polymeric tubular film include low density polyethylene, linear low density polyethylene, high density polyethylene, polyester, polypropylene, ethylene-propylene copolymer, ethylene-propylene-butene-1 terpolymer, propylene-butene-1 copolymer, ethylene vinyl acetate, polyamide, polylactic acid, polyester from sugar cane or corn derived ethanol, and starch-based polymers. The surface layer of the tubular film on the inside of the tube (sterilized inside of the tube) may be a heat sealable polymeric layer selected from the group consisting of low density polyethylene, linear low density polyethylene, ethylene-propylene copolymer, ethylene-propylene-butene-1 terpolymer, ethylene vinyl acetate, propylene-butene-1 copolymer. The thickness of the single layer or multi-layer polymeric tubular film used to form the flexible body 212 of the plastic sterilized bag 210 may range from 0.5 to 20 mils, or 1.0 to 15 mils, or 1.5 to 10 mils, or 2.0 to 8 mils, or 2.25 to 7.5 mils, or 2.5 to 6 mils, or 2.75 to 5 mils, or 3 to 4 mils.

In one advantageous form, the flexible body 212 of the sterilized plastic bag 210 may be formed from low density polyethylene film or linear low density polyethylene film and has a thickness ranging from 2.25 to 3 mils.

The single or multi-layer polymeric tubular film used to form the flexible body 212 of the sterilized plastic bag 210 may be formed into a bag utilizing the bag forming processes and equipment described above. The top heat seal area 217, side heat seal areas 216 and bottom heat seal area 218 of the flexible body 212 of the bag 210 may be formed utilizing heat sealing technology requiring temperature control, pressure control and residence time control. The top heat seal area 217, side heat seal areas 216 and bottom seal area 218 of the flexible body 212 of the bag 210 may range in width from 0.1 to 2 inches, or 0.15 to 1.5 inches, or 0.2 to 1.2 inches, or 0.3 to 1 inch, or 0.4 to 0.8 inches, or 0.5 to 0.7 inches.

The closure strips 232 of the optional bag closing mechanism 230 and the optional pull tabs 240 may be formed from single or multi-layer polymeric tapes or strips. Non-limiting exemplary materials that may be used to form the single or multi-layer polymeric tapes or strips include low density polyethylene, linear low density polyethylene, high density polyethylene, polyester, polypropylene, ethylene vinyl acetate, polyamide, polylactic acid, metallized polyester, metallized polypropylene, metallized polyamide, metallized polyethylene, polyester from sugar cane or corn derived ethanol, and starch-based polymers. In one advantageous form, the closure strips 232 and pull tabs 240 may be formed from high density polyethylene, low density polyethylene or linear low density polyethylene.

The closure strips 232 of the optional bag closing mechanism 230 and/or the optional pull tabs 240 may be optionally reverse printed, surface printed or surface coated. A reverse printed closure strip 232 and/or pull tab 240 provides for improved scuff resistance and prevention of removal from alcohol swabbing the bag 210. In another form, the closure strips 232 of the optional bag closing mechanism 230 and/or the optional pull tabs 240 may be optionally surface printed with a colored ink to allow for ease of detection with yellow ink or white ink being particularly advantageous.

The ink used for the various sections of the sterilized plastic bags disclosed herein may be a solvent or water based system. Non-limiting exemplary ink systems include acrylic, cellulosic, epoxy, urethane or polyvinylidene dichloride (PVDC) systems. The ink may be applied to the removable tear strip 226 of the bag 210 and other portions of the bag 210 described above (closure strips 232, pull tabs 240, flexible body 212) utilizing flexographic or rotogravure printing processes in-line with and integrated into the bag making process 60. In one advantageous form, the ink is blue in color and covers substantially the entire surface area of the removable tear strip 226 of the sterilized bag 210.

The closure strips 232 of the optional bag closing mechanism 230 may also optionally include a malleable wire 236 embedded within the closure strip 232. In an advantageous form as shown in FIG. 4, the malleable wire 236 is centered both top to bottom and side to side within the closure strip 232. Non-limiting exemplary materials that may be used for the malleable 236 include aluminum, bronze, copper, nickel, cobalt, brass, copper-zinc alloys, and zinc. The malleable wire 236 thickness may range from 5 gauge to 100 gauge, or 8 gauge to 90 gauge, or 10 gauge to 80 gauge, or 15 gauge to 70 gauge, or 20 gauge to 50 gauge, or 25 gauge to 40 gauge.

### Method of Use of the Sterilized Bag Produced by the Above Inventive Method

The sterilized plastic bags disclosed herein are useful as samples bags for various types of products, including, but not limited to, foods, pharmaceuticals, resins, solid additives, liquids, etc.

In one embodiment of the method of using a sterilized plastic bag to collect and retain a product sample and eliminate product contamination comprises the steps of:
1) providing sterilized plastic bag comprising a flexible body formed from a single or multi-layer polymeric film including an opposed front wall and back wall sealed together around the periphery of the front wall and the back wall to form an internal collection space including two side heat seal areas, a top heat seal area and a bottom heat seal area, and a bag opening mechanism located proximate a top edge of the flexible body and below the top seal area, wherein the bag opening mechanism includes one or more perforations, scores or cuts in the one or two side heat seal areas and optionally the front and back wall to form a removable tear strip;
2) removing the removable tear strip from the plastic bag; and
3) filling the internal collection space with a product sample.

In another embodiment of the method of using a sterilized plastic bag to collect and retain a product sample and eliminate product contamination comprises the steps of:
1) providing a plastic bag comprising a flexible body formed from a single or multi-layer polymeric film including an opposed front wall and back wall sealed together around the periphery of the front wall and the back wall to form an internal collection space including two side heat seal areas, a top heat seal area and a bottom heat seal area, and a bag opening mechanism located proximate a top edge of the flexible body and below the top seal area, wherein the bag opening mechanism includes one or more perforations, scores or cuts in the one or two side seal areas and optionally the front and back wall to form a removable tear strip, a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag and, wherein the first closure strip and the second closure strip include a malleable wire embedded in the closure strip that traverses substantially the entire length of the closure strip or that traverses a majority of the length of the closure strip, wherein the malleable wire is selected from the group consisting of aluminum, bronze, copper, nickel, cobalt, brass, copper-zinc alloys, and zinc, and one or more pull tabs affixed to the front wall, the back wall or a combination, wherein the one or more pull tabs are located between the first closure strip and the front wall, between the second closure strip and the back wall, or a combination thereof;
2) removing the removable tear strip from the plastic bag;
3) filling the internal collection space with a product sample; and
4) closing the bag including the product sample with the bag closing mechanism.

### OTHER EMBODIMENTS

A1. A method of making a sterilized flat plastic bag comprising: i) forming a roll of a tubular polymeric film in a blown film extrusion process, wherein the roll ranges in width from 6 inches to 60 inches; ii) providing the roll of tubular polymeric film to a bag making process comprising the steps of: a) unwinding the roll of tubular polymeric film, b) continuously heat sealing the unwound tubular polymeric film proximate the machine direction (longitudinal direction) edges and periodically heat sealing along the transverse direction to form bag side heat seals and end heat seals respectively, and c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top end heat seal area and a bottom end heat seal area, with the proviso that the tubular film is not slit in the longitudinal direction during any step of the method, and with the proviso that the sterilized flat bag is not subjected to a separate sterilizing step during any step of the method.

A2. The method of paragraph A1, further including the step in the bag making process of providing a bag opening mechanism located proximate a top edge of the sterilized flat plastic bag and below the top end heat seal area, wherein the bag opening mechanism includes one or more perforations, scores or cuts in the side heat seal areas and optionally the front wall and the back wall of the sterilized flat plastic bag to form a removable tear strip.

A3. The method of paragraph A1 or A2, further including the step in the bag making process of providing a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag.

A4. The method of paragraph A3, wherein the first closure strip, the second closure strip or a combination thereof further include a malleable wire embedded in the closure strip that traverses substantially the entire length of the closure strip or that traverses a majority of the length of the closure strip, wherein the malleable wire is selected from the group consisting of aluminum, bronze, copper, nickel, cobalt, brass, copper-zinc alloys, and zinc.

A5. The method of paragraph A4, wherein the malleable wire is recessed relative to the two ends of the first closure strip and the two ends of the second closure strip.

A6. The method of paragraph A3 (or A4-A5), wherein the first and second closure strips extending beyond the side edges of the bag are not sealed together beyond the side edges of the bag, are sealed together beyond the side edges of the bag, or a combination thereof.

A7. The method of paragraph A3 (or A4-A6), wherein the first closure strip sealed to the front wall of the bag and the second closure strip sealed to the back wall of the bag are heat seals, adhesive seals, ultrasonic seals or a combination thereof.

A8. The method of paragraph A3 (or A4-A7), wherein the first closure strip, the second closure strip or a combination thereof are surface or reverse printed prior to sealing to the walls of the bag.

A9. The method of paragraph A3 (or A4-A8) further including the step in the bag making process of providing one or more pull tabs affixed to the front wall of the bag, the back wall of the bag or a combination thereof.

A10. The method of paragraph A9, wherein the one or more pull tabs are located between the first closure strip and the front wall, between the second closure strip and the back wall, or a combination thereof.

A11. The method of paragraph A10, wherein a first pull tab is located about midway between the two side edges of the bag between the first closure strip and the front wall of the bag and a second pull tab is located about midway between the two side edges of the bag between the second closure strip and the back wall, and wherein the first pull tab and the second pull tab are opposite each other.

A12. The method of paragraph A1 (or A2-A11), wherein the polymeric tubular film is a single or multi-layer polymeric film including from one to six layers selected from the group consisting of low density polyethylene, linear low density polyethylene, high density polyethylene, polyester, polypropylene, ethylene-propylene copolymer, ethylene-propylene-butene-1 terpolymer, propylene-butene-1 copolymer, ethylene vinyl acetate, polyamide, polylactic acid, polyester from sugar cane or corn derived ethanol, and starch-based polymers.

A13. The method of paragraph A12, wherein the multi-layer polymeric tubular film includes a heat sealable polymeric surface layer on the inside of the tube selected from the group consisting of low density polyethylene, linear low density polyethylene, ethylene-propylene copolymer, ethylene-propylene-butene-1 terpolymer, ethylene vinyl acetate, and propylene-butene-1 copolymer.

A14. The method of paragraph A1 (or A2-A13), further including the step in the bag making process of printing at least a portion of an outside surface of the unwound tubular polymeric film with a water-based ink or a solvent-based ink utilizing a flexographic or a rotogravure printing process integrated between the unwinding and heat sealing steps of the bag making process.

A15. The method of paragraph A1 (or A2-A14), further including the step in the bag making process of stacking two or more heat sealed sterilized flat plastic bags on top of each other to form stacked heat sealed sterilized flat plastic bags.

A16. The method of paragraph A1 (or A2-A15), further including the step in the bag making process of packaging the stacked heat sealed sterilized flat plastic bags for transport and shipment.

A17. A sterilized flat plastic bag made according to the method of paragraph A1 (or A2-A16).

A18. The sterilized flat plastic bag of paragraph A17, wherein the bag provides for increased strength against tear or rupture when filled with product sample compared to a substantially similar sterilized flat plastic bag that is not heat sealed in the machine direction (longitudinal direction).

B1. A method of using a sterilized plastic bag to collect and retain a product sample and eliminate product contamination comprising: i) forming a sterilized flat plastic bag from the following steps: forming a roll of a tubular polymeric film in a blown film extrusion process, wherein the roll ranges in width from 6 inches to 60 inches; providing the roll of tubular polymeric film to a bag making process comprising the steps of: a) unwinding the roll of tubular polymeric film, b) continuously heat sealing the unwound tubular polymeric film proximate the machine direction (longitudinal direction) edges and periodically heat sealing along the transverse direction to form bag side heat seals and end heat seals respectively, and c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top heat seal area and a bottom heat seal area, d) forming a bag opening mechanism located proximate a top edge of the sterilized flat plastic bag and below the top heat seal area, wherein the bag opening mechanism includes one or more perforations, scores or cuts in the side heat seal areas and optionally the front wall and the back wall of the sterilized flat plastic bag to form a removable tear strip, e) forming a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag, and, wherein the first closure strip and the second closure strip include a malleable wire embedded in the closure strip that traverses substantially the entire length of the closure strip or that traverses a majority of the length of the closure strip, f) forming one or more pull tabs affixed to the front wall, the back wall or a combination, wherein the one or more pull tabs are located between the first closure strip and the front wall, between the second closure strip and the back wall, or a combination thereof, and with the proviso that the tubular film is not slit in the longitudinal direction during any step of the method, and with the proviso that the sterilized flat bag is not subjected to a separate sterilizing step during any step of the method, ii) removing the removable tear strip from the sterilized plastic bag; iii) opening the sterilized plastic bag with the one or more pull tabs; iv) filling the internal collection space of the open sterilized plastic bag with a product sample; and v) closing the filled open sterilized plastic bag with the bag closing mechanism.

B2. The method of paragraph B1, wherein the filled sterilized plastic bag provides for increased strength against tear or rupture compared to a substantially similar filled bag that is not heat sealed in the machine direction (longitudinal direction).

It should be understood that the foregoing description is only illustrative of the aspects of the disclosed embodiment and that the aspects of the disclosed embodiment can be used individually or in any suitable combination thereof. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

All patents, test procedures, and other documents cited herein, including priority documents, are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated.

Those skilled in the art will recognize or be able to ascertain using no more than routine experimentation, many equivalents to the specific embodiments and methods described herein. Such equivalents are intended to be encompassed by the scope of the following claims.

What is claimed is:

1. A method of making a sterilized flat plastic bag comprising:
i) forming a roll of a tubular polymeric film in a blown film extrusion process, wherein the roll ranges in width from 6 inches to 60 inches;
ii) providing the roll of tubular polymeric film to a bag making process comprising the steps of:
a) unwinding the roll of tubular polymeric film,
b) continuously heat sealing the unwound tubular polymeric film proximate the machine direction (longitudinal direction) edges and periodically heat sealing along the transverse direction to form bag side heat seals and end heat seals respectively, and
c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top end heat seal area and a bottom end heat seal area,
with the proviso that the tubular film is not slit in the longitudinal direction during any step of the method, and
with the proviso that the sterilized flat bag is not subjected to a separate sterilizing step during any step of the method.

2. The method of claim 1, further including the step in the bag making process of providing a bag opening mechanism located proximate a top edge of the sterilized flat plastic bag and below the top end heat seal area, wherein the bag opening mechanism includes one or more perforations, scores or cuts in the side heat seal areas and optionally the front wall and the back wall of the sterilized flat plastic bag to form a removable tear strip.

3. The method of claim 2, further including the step in the bag making process of providing a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag.

4. The method of claim 3, wherein the first closure strip, the second closure strip or a combination thereof further include a malleable wire embedded in the closure strip that traverses substantially the entire length of the closure strip or that traverses a majority of the length of the closure strip, wherein the malleable wire is selected from the group consisting of aluminum, bronze, copper, nickel, cobalt, brass, copper-zinc alloys, and zinc.

5. The method of claim 4, wherein the malleable wire is recessed relative to the two ends of the first closure strip and the two ends of the second closure strip.

6. The method of claim 3 wherein the first and second closure strips extending beyond the side edges of the bag are not sealed together beyond the side edges of the bag, are sealed together beyond the side edges of the bag, or a combination thereof.

7. The method of claim 3, wherein the first closure strip sealed to the front wall of the bag and the second closure strip sealed to the back wall of the bag are heat seals, adhesive seals, ultrasonic seals or a combination thereof.

8. The method of claim 3, wherein the first closure strip, the second closure strip or a combination thereof are surface or reverse printed prior to sealing to the walls of the bag.

9. The method of claim 3 further including the step in the bag making process of providing one or more pull tabs affixed to the front wall of the bag, the back wall of the bag or a combination thereof.

10. The method of claim 9, wherein the one or more pull tabs are located between the first closure strip and the front wall, between the second closure strip and the back wall, or a combination thereof.

11. The method of claim 10, wherein a first pull tab is located about midway between the two side edges of the bag between the first closure strip and the front wall of the bag and a second pull tab is located about midway between the two side edges of the bag between the second closure strip and the back wall, and wherein the first pull tab and the second pull tab are opposite each other.

12. The method of claim 1, wherein the polymeric tubular film is a single or multi-layer polymeric film including from one to six layers selected from the group consisting of low density polyethylene, linear low density polyethylene, high density polyethylene, polyester, polypropylene, ethylene-propylene copolymer, ethylene-propylene-butene-1 terpolymer, propylene-butene-1 copolymer, ethylene vinyl acetate, polyamide, polylactic acid, polyester from sugar cane or corn derived ethanol, and starch-based polymers.

13. The method of claim 12, wherein the multi-layer polymeric tubular film includes a heat sealable polymeric surface layer on the inside of the tube selected from the group consisting of low density polyethylene, linear low density polyethylene, ethylene-propylene copolymer, ethylene-propylene-butene-1 terpolymer, ethylene vinyl acetate, and propylene-butene-1 copolymer.

14. The method of claim 1, further including the step in the bag making process of printing at least a portion of an outside surface of the unwound tubular polymeric film with a water-based ink or a solvent-based ink utilizing a flexographic or a rotogravure printing process integrated between the unwinding and heat sealing steps of the bag making process.

15. The method of claim 1, further including the step in the bag making process of stacking two or more heat sealed sterilized flat plastic bags on top of each other to form stacked heat sealed sterilized flat plastic bags.

16. The method of claim 15, further including the step in the bag making process of packaging the stacked heat sealed sterilized flat plastic bags for transport and shipment.

17. A sterilized flat plastic bag made according to the method of claim 1.

18. The sterilized flat plastic bag of claim 17, wherein the bag provides for increased strength against tear or rupture when filled with product sample compared to a substantially similar sterilized flat plastic bag that is not heat sealed in the machine direction (longitudinal direction).

19. A method of using a sterilized plastic bag to collect and retain a product sample and eliminate product contamination comprising:
i) forming a sterilized flat plastic bag from the following steps:
forming a roll of a tubular polymeric film in a blown film extrusion process,
wherein the roll ranges in width from 6 inches to 60 inches;
providing the roll of tubular polymeric film to a bag making process comprising the steps of:
a) unwinding the roll of tubular polymeric film,
b) continuously heat sealing the unwound tubular polymeric film proximate the machine direction (longitudinal direction) edges and periodically heat sealing along the transverse direction to form bag side heat seals and end heat seals respectively, and
c) cutting the heat sealed unwound tubular polymeric film periodically along the transverse direction to form a heat sealed sterilized flat plastic bag including an opposed front wall and back wall heat sealed together around the periphery of the front wall and the back wall to form an internal collection space including two side heat seal areas, a top heat seal area and a bottom heat seal area,
d) forming a bag opening mechanism located proximate a top edge of the sterilized flat plastic bag and below the top heat seal area, wherein the bag opening mechanism includes one or more perforations, scores or cuts in the side heat seal areas and optionally the front wall and the back wall of the sterilized flat plastic bag to form a removable tear strip,
e) forming a bag closing mechanism located proximate and below the removable tear strip, wherein the bag closing mechanism includes a first closure strip sealed to the front wall of the bag and a second closure strip sealed to the back wall of the bag, wherein the first and second closure strips are opposed to each other and extend beyond the side edges of the bag, and, wherein the first closure strip and the second closure strip include a malleable wire embedded in the closure strip that traverses substantially the entire length of the closure strip or that traverses a majority of the length of the closure strip,
f) forming one or more pull tabs affixed to the front wall, the back wall or a combination, wherein the one or more pull tabs are located between the first closure strip and the front wall, between the second closure strip and the back wall, or a combination thereof, and
with the proviso that the tubular film is not slit in the longitudinal direction during any step of the method, and with the proviso that the sterilized flat bag is not subjected to a separate sterilizing step during any step of the method,
ii) removing the removable tear strip from the sterilized plastic bag;
iii) opening the sterilized plastic bag with the one or more pull tabs;
iv) filling the internal collection space of the open sterilized plastic bag with a product sample; and
v) closing the filled open sterilized plastic bag with the bag closing mechanism.

20. The method of claim 19, wherein the filled sterilized plastic bag provides for increased strength against tear or rupture compared to a substantially similar filled bag that is not heat sealed in the machine direction (longitudinal direction).
